(19) United States
(12) Patent Application Publication
(10) Pub. No.: US 2013/0101110 A1
(43) Pub. Date: Apr. 25, 2013

(54) SYSTEM AND METHOD FOR ATTACHING GEOGRAPHIC INFORMATION TO CUSTOMER REPORTS

(71) Applicant: Norbrook Laboratories, Newry (GB)

(72) Inventor: James Quinton Stewart HAUGHEY, Newry (GB)

(73) Assignee: Norbrook Laboratories, Newry (GB)

(21) Appl. No.: 13/660,373

(22) Filed: Oct. 25, 2012

Related U.S. Application Data
(60) Provisional application No. 61/550,934, filed on Oct. 25, 2011.

(51) Int. Cl. H04M 3/00

(52) U.S. Cl. 379/265.09

(57) ABSTRACT

The invention relates to methods of managing a geographically distributed sales force and ensuring accurate reporting from geographically distributed customers by the sales force.

### CROSS-REFERENCE TO RELATED APPLICATION(S)

This application claims priority from U.S. Provisional Application No. 61/550,934 filed Oct. 25, 2011, titled “SYSTEM AND METHOD FOR ATTACHING GEOGRAPHIC INFORMATION TO CUSTOMER REPORTS”, the disclosure of which is incorporated by reference herein in its entirety.

### FIELD OF THE INVENTION

This invention relates to systems and methods for determining and attaching geographic information to customer visit reports.

### BACKGROUND OF THE INVENTION

Many companies rely on employees to visit geographically distributed customers as part of their marketing and sales efforts. The companies rely on these employees to faithfully record information related to the customer such as name, address, nature of business, most bought products, potential to market new products to customer, and similar business sensitive information. Due to the time constraints that some of these employees face, sometimes, not all the information is recorded. For example, the most basic information such as the customer name and location is sometimes forgotten, which then requires the employee to later review the saved records and try and match up a particular record to a particular customer based from memory. This can lead to information being attributed to the wrong customer.

Additionally, managers rely on the employees to be truthful in their reporting of visits to the geographically distributed customers. Unscrupulous employees are able to manipulate the records to give the impression that they have visited customers when they have not. Managers also may wish to give instructions to the employees, such as an instruction to visit a particular customer, but can only do so if the manager knows where the employee is at any given time.

There is a need, therefore, for a system and method of generating and recording geographic information, further for attaching the geographic information to customer reports to manage a sales force.

### SUMMARY OF THE INVENTION

Methods and systems for generating customer reports are described herein. In some embodiments, a system includes a remote device for generating customer reports. The remote device has a memory and a processor configured to execute instructions for receiving customer information. The processor is further configured for determining geographic information associated with a geographic position of the remote device and for attaching the geographic information to the customer information to generate a customer report. The processor is also configured to transmit the customer report.

In some embodiments, a method for generating customer reports includes receiving, by a remote device, customer information. The method also includes determining geographic information associated with a geographic position of the remote device. The method further includes attaching the geographic information to the customer information to generate a first customer visit report, and transmitting the first customer visit report.

Aspects of the invention are also directed to methods for managing a geographically distributed sales force. The method includes receiving, by a plurality of remote devices, a plurality of customer information and generating a customer visit report for each customer information. Generating includes attaching geographic information associated with a geographic position of the remote device receiving the each customer information. The method also includes transmitting each customer visit report upon said generating.

### BRIEF DESCRIPTION OF THE DRAWINGS

FIG. 1 is a schematic illustration of an invention, according to an embodiment.

FIG. 2 is a flowchart of a method of generating customer visit reports, according to an embodiment.

FIG. 3 is a flowchart of a method of managing a geographically distributed sales force, according to an embodiment.

FIG. 4 is an exemplary illustration of a meeting report template for entering information related to customer visits via the remote entry device, according to an embodiment.

FIGS. 5A-5B are exemplary screen shots of an administrator device, according to embodiments.

FIGS. 6A-6B are exemplary screen shots of the remote device, according to embodiments.

FIG. 7 is an exemplary illustration of a list of tasks assigned to various employees via the administrator device, according to an embodiment.

FIGS. 8A-8B are exemplary screen shots of the remote device, according to embodiments.

### DETAILED DESCRIPTION

As used in this specification, the singular forms “a,” “an” and “the” include plural referents unless the context clearly dictates otherwise. Thus, for example, the term “a network” is intended to mean a single network or a combination of networks.

Systems and methods for determining and attaching geographic information to customer visit reports generated by a sales force are described herein. This approach cures the deficiencies of the prior art by automatically attaching geographic information (i.e. without user input) such as a GPS coordinates to customer information generated by a field agent, during a field visit to the customer's location, for example. Accordingly, such systems and methods can be used by employers of the field agent to not only ensure that location information is accurately located, but also to ensure that the field agent did indeed visit the customer at the specified location.

In some embodiments, a system has a remote device for generating geographically distributed customer reports, such as by a user of the remote device, a field agent for example. The remote device has a memory and a processor. The remote device is configurable to receive customer information from the user such as customer name, address, etc. Additionally, the remote device is configurable to determine geographic information associated with a geographic position of the remote device, such as the GPS coordinates of the remote device. When the GPS coordinates are automatically determined by the remote device, it prevents human error, intervention and manipulation.

The remote device is further configurable to attach the geographic information to the customer information to generate a customer report. In some embodiments, the customer report also includes user information. For example, when the user is a sales agent, the user information can include manually entered check-in time points that correspond to when he starts work for the day, when he starts driving to a customer, if he stops for lunch while traveling, and/or the like. In some embodiments, the remote device transmits the customer report to a central server, which receives and stores the customer report.

The stored customer report can be consumed in any suitable manner. In some embodiments, an entity such as an employer of the user of the remote device can access the customer report directly from an interface of the central server. In some embodiments, an administrator device can be employed for viewing the customer report stored on the central server.

The administrator device can view the customer report, or aspects of the customer report, in any suitable manner. In some embodiments, the administrator device comprises an interface for viewing the geographic information of the customer report on a map.

The administrator device can communicate directly with the central server to retrieve the customer report. In some embodiments, the administrator device can communicate directly with the remote device to send instructions to the remote device. For example, the instructions can be a task list and/or a list of customers for the field agent to visit. In this manner, when the field agent indicates in the customer report that he/she did visit the customer as directed, the geographic information can be used to check the veracity of the agent's claim.

In some embodiments, a method for managing a geographically distributed sales force is disclosed herein. The remote device can receive customer information and generate a customer visit report. The customer visit report includes the customer information as well as geographic information associated with a geographic position of the remote device at the time of receiving the each customer information. The geographic information is automatically determined and appended, attached, or otherwise associated with the customer information to generate the customer visit report.

In some embodiments, many remote devices can exist, each generating customer reports in a manner similar to that described above. In other words, aspects of the invention are extendible and scalable for multiple remote devices being operated by multiple users (e.g. multiple field agents, such as a sales task force).

The customer visit reports can be transmitted to a central server, which receives and stores the reports in any suitable manner. In some embodiments, one or more central servers receive customer visit reports from multiple remote devices.

The customer visit report stored on the central server can be accessed by an administrator device. An administrator device can be any device that permits a user with administrative rights to the customer visit reports to access the reports.

In some embodiments, two or more customer visit reports can be compared. In some embodiments, comparing the reports can include comparing reports for an individual parameter such as an individual agent. For example, reports for an individual agent can be compared to determine the distance he has travelled, to determine if the agent could plausibly have visited all the customers he claimed to visit, to see how long it took the agent to travel from one customer to the next, and/or the like. In another non-limiting example, comparing can also include comparing reports of many individuals/agents to determine trends in buying for particular geographic locations, products sold or discussed by individual agents, and/or the like. In some embodiments, reports can be compared after downloading on the administrator device. In some embodiments, reports can be compared by the administrator device while still resident on the central server.

In some embodiments, a user of the administrator device can view the geographic information of the customer visit report on a map. In some embodiments, the central server stores a plurality of customer visit reports received from a plurality of remote devices, and the user of the administrator device can view the geographic information of some and/or all customer visit reports on the same map. In some embodiments, the customer visit reports selected to be displayed on the map can be filtered based on any data field(s) in the customer visit report, including, but not limited to, one or more of customer name, product sold, date range, sales representative, and/or the like.

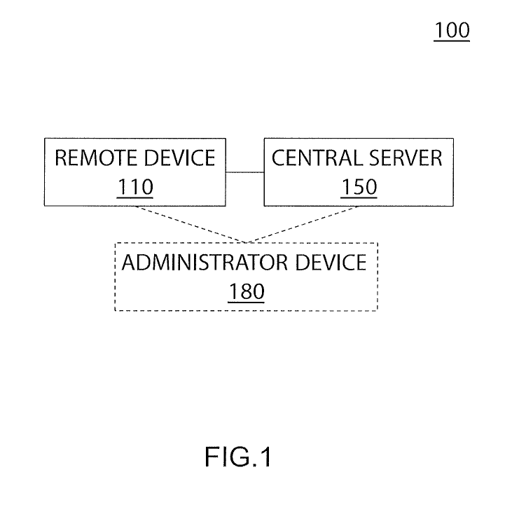

FIG. 1 is a schematic illustration of an environment or system 100 within which aspects of the invention may be implemented. The system 100 includes a remote entry device 110 and a central server 150. The system can also optionally include an administrator device 180. The various components of the system 100 may be in communication as indicated by lines in FIG. 1 via a network, which may be any type of network (e.g., a local area network or LAN, a wide area network or WAN, a virtual network, a telecommunications network such as a cellular telephone network, and/or the internet) implemented as a wired network and/or a wireless network. Any or all communications may be secured (e.g., encrypted) or unsecured, as is known in the art. In some embodiments, the administrator device 180 can directly communicate with the central server 150. In some embodiments, the administrator device 180 can directly communicate with the remote entry device 110.

The remote entry device 110 can be any device capable of recording customer information and generating customer visit reports. In some embodiments, the remote entry device can be a portable computer, laptop, cellphone, smartphone, such as iPhone, Blackberry, Android, and the like, personal digital assistant (PDA), iPad, or other tablet device.

The administrator device 180 can be any device capable of viewing customer visit reports. In some embodiments, the administrator device can be a portable computer, laptop, smartphone, such as iPhone, Blackberry, Android, and/or the like, iPad, or other tablet device.

The central server 150 can include hardware and/or software that serve the needs of other hardware and/or software and requests received from other hardware and/or software, which collectively are known in the art as clients. In some embodiments, a central server can be a database server, a file server, a mail server, a print server a web server and/or the like. In some embodiments, the central server 150 can be supplied as part of the overall system 100, which can include the remote entry device 110 and/or the administrator device 180. In other embodiments, the central server 150 can be part of an existing web based system, such as a central server that is part of a third party mail service provider. For example, the central server can be a Hotmail server, a Googlemail server, a Yahoo mail server, or a document server provided by any of these third party providers. The remote entry device 110 and/or the communications networks it uses, has to be able to determine and/or provide some manner of geographical information about the remote device's location, and thus its user's location. Numerous techniques and mechanisms can be used to provide this information. In some embodiments, a user (e.g. a field agent) explicitly identifies his or her current location to the remote entry device 110. In some embodiments, the remote entry device 110 itself, or in operation with the communications network it utilizes, determines the remote entry device's location.

In the case of the remote entry device 110, various positioning technologies and techniques can be used. In general, positioning technologies calculate, measure, and/or otherwise determine the physical location of the remote entry device 110, and communicate this information to the remote entry device for attaching to the customer report. Positioning technologies can use purely device-based approaches, they can utilize information from the communications network, or some combination of the two. Many positioning technologies use some portion of the network, allowing service providers to retain the data (e.g., to ensure its use generates revenue for them). In some instances, network-based positioning technologies allow for the consumption of fewer communication device resources (e.g., power, computing resources, memory, etc.). Moreover, network-centric solutions typically allow the use of communications devices without modification, e.g., it does not matter what specific type of cell phone a user is using.

Examples of network-centric positioning solutions include, but are not limited to, cell-ID/cell site sector, enhanced cell-ID, and enhanced observed time difference (E-OTD). Cell-ID/cell site sector positioning technology is the most widely used cell phone network technique. This technique uses existing data from the network to identify the radio cell site and sector in which a user is located. Consequently, location accuracy is dependent on cell size. While this solution works well in dense urban areas, e.g., enabling positioning down to a city block, it is far less accurate in suburban or rural areas where a cell might cover many square miles. Enhanced cell-ID is another network technology combining cell ID (CI) with one or more other technologies. The level of accuracy is increased over basic CI, often ranging from 75-500 meters. For example, in GSM networks, CI can be combined with timing advance information (which measures handset range from the base station, including whether or not the handset is connected to the nearest cell) and/or received signal level (which measures average signal strength). In W-CDMA networks, CI can be combined with round-trip-time (i.e., a feature of the W-CDMA standard similar to GSM's timing advance) data to improve location accuracy. E-OTD is a network technology that requires additional software on the mobile device and the addition of global positioning system (GPS) or similar positioning system receivers to base stations. Here, the mobile device (e.g. the remote entry device 110) calculates a user's position by triangulating the differing arrival times of network synchronization data regularly transmitted between handset and base station. A related technique is time difference of arrival (TDOA). TDOA also uses triangulation and time delay, but the processing is performed instead on the network side of the communication link.

Remote entry device centric solutions can include GPS and assisted GPS. Using GPS satellites, the remote entry device 110 can determine its location itself and to a high degree of accuracy where the satellite signal is good. This technique is less effective indoors, and may draw heavily on device power if the position is determined frequently regularly. Similarly, the user may experience noticeable delays if the calculations are performed on-demand. With assisted-GPS (A-GPS) the remote entry device 110 is supplemented with network information to provide additional accuracy and speed of location determination. GPS receivers are connected to the network at various known geographic points to provide additional data to the remote entry device, greatly reducing the time needed to get positioning information and thereby allowing longer battery life. Certain A-GPS variants can also provide better in-building location coverage and accuracy.

Other techniques can be additionally or alternatively used for determining the position of the remote entry device, including analysis of radio behavior to position the handset, and to calculate distances, angles of reception and signal strengths. Such techniques can vary depending on the particular technique used. Moreover, various techniques can be combined to provide certain advantages.

Wi-Fi hotspots can also be used to determine the geographic location of the remote entry device. Such a Wi-Fi hotspot can be provided by businesses (e.g., coffee shops, book stores, etc.), public facilities (e.g., airports, parks, etc.) private facilities or homes, and the like. A remote entry device using a Wi-Fi hotspot can include some of the same types of self-locating capabilities previously described. For example, U.S. Pat. No. 5,835,061, U.S. Pat. No. 6,414,635, and U.S. Patent Publication No. 2002/0173981 describe various techniques for determining, providing, and utilizing geographic location information in conjunction with communications devices using a so-called Wi-Fi hotspot. These documents are incorporated by reference herein in their entirety.

The customer visit report, including the geographic information and the customer information entered via the remote entry device 110 is sent via one of the disclosed networks to the central server 150, where it is stored. The central server 150 can store the report in any format, such as in database, spreadsheet, word processing document, and/or the like. In some embodiments, a user of the central server 150 can access the report directly at the central server. In some embodiments, the administrator device 180 can access the data stored on the central server by connecting to the central server via one of the disclosed networks. Reviewing the geographic information via the central server 150 and/or the administrator device 180 can be accomplished in several ways. In some embodiments, the geographic information is overlaid on a computer generated map. For example, the geographic information can be viewed on a map viewed on the internet, such as is available at www.google.com/maps. Other methods of viewing the geographic information are available and will be readily apparent to one of skill in the art. In some embodiments, the geographic information is used to populate a spreadsheet and/or database being used to automatically calculate the distance a sales employee has travelled. This method involves taking all the geographic information populating the spreadsheet or database that is associated with a particular sales employee and using services, such as Google Maps, or other accessible map tools to calculate the distance travelled by the.particular employee.

The administrator device 180 can communicate individual tasks, to-do lists, news, and/or otherwise send information to a user of the remote entry device 110. In some embodiments, the instructions can include any general instructions to a sales force such as to visit a particular customer, instructions to discuss or promote a particular product, instructions as to any discounts that may be applied to particular products or customers, and/or the like.

In some embodiments, the instructions sent by the administrator device 180 to the remote entry device 110 can be routed through the central server 150. In some embodiments, the administrator device 180 can send the instructions directly to the remote entry device 110. In some embodiments, the selection of a particular method of sending the instructions will depend on the network to which the remote entry device 110 and administrator device 180 are connected. For example, if both the remote entry device 110 and administrator device 180 are smart phone devices, the instructions may be sent via the cellular telephone network to which one, or both of the devices are connected.

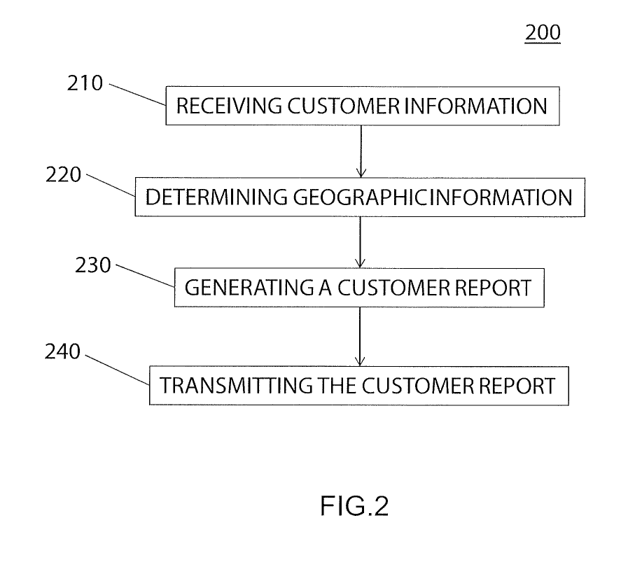

Aspects of the invention are also directed to a method 200 of generating customer visit reports, as generally illustrated in FIG. 2, and described herein with respect to the illustration and associated description of FIG. 1. In some embodiments, the method 200 is executed by the remote entry device 110. The method 200 includes receiving, at 210, customer information from a user of the remote entry device 110. The customer information can include customer name, the products sold or discussed, the value of any sales, and/or the like. At 220, geographic information associated with a geographic position of the remote entry device 110 is determined in any suitable manner, such as via GPS. At 230, a customer report is generated by attaching the geographic information to the customer information. At 240, the customer report is transmitted. In some embodiments, the customer report is transmitted to the central server 150.

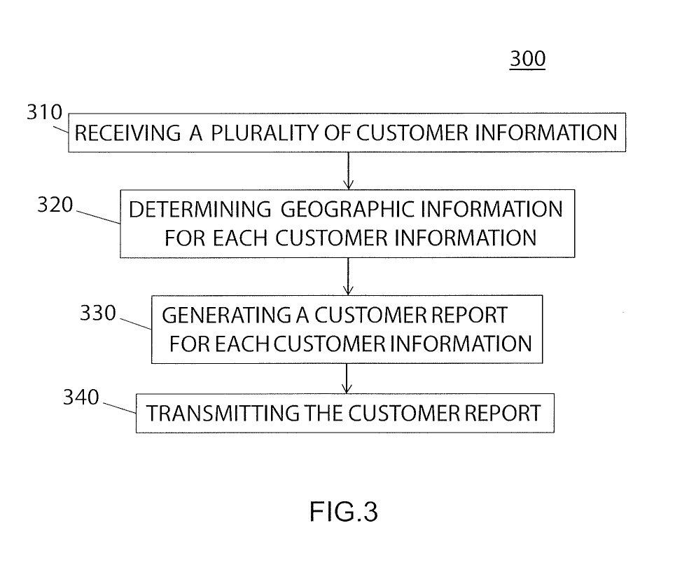

Aspects of the invention are also directed to methods for managing a geographically distributed sales force, as generally illustrated in FIG. 3. At 310, a plurality of remote devices receive a plurality of customer information. In some embodiments, the plurality of remote devices are associated with a geographically distributed sales force. At 320, each remote device 110 determines geographic information associated with a geographic position of the remote device 110 for each customer information it receives. At 330, a customer visit report is generated for each customer information by attaching geographic information associated with a geographic position of the remote device 110 receiving the each customer information. At 340, the generated customer visit report is transmitted, to the central server 150, for example.

It is understood that each remote device 110 can perform these functions independent of each other remote device. In other words, each remote device 110 independently receives customer information, determines geographic information, generates a customer visit report, and transmits the customer visit report. Further, each remote device 110 performs this function for each customer information it receives independent of other customer information received by it or by other remote devices.

In this manner, an administrator and/or an administrator device can access the multiple customer reports generated, and view the customer/geographic information associated therewith in any suitable manner. For example, the administrator can view geographic information on a map for some and/or all of the remote devices.

The systems and methods discussed herein can be implemented in software using a variety of computer languages, including, for example, computer languages such as C, C++, C#, Objective C, Java, JavaScript, VBScript, JScript, PHP, Peri, SQL; development environments/tools such as Active Server Pages (ASP), JavaServer Pages (JSP), Apple's Xcode, and ColdFusion; and interface tools such as the Common Gateway Interface (CGI). Additionally, software can be provided to the computer system via a variety of computer readable media including electronic media (e.g., flash memory), magnetic storage media (e.g., hard disk, a floppy disk, etc.), optical storage media (e.g., CD-ROM), and communications media conveying signals encoding the instructions (e.g., via a network coupled to network interface).

The computer system can also include devices such as keyboard and mouse, SCSI interface, network interface (wireless and/or wired), graphics and display, hard disk, and CD-ROM, all of which are coupled to processor by a communications bus. It will be apparent to those having ordinary skill in the art that the computer system can also include numerous elements, such as additional storage devices, communications devices, input devices, and output devices, including PDAs, smartphones and tablet computers.

In some embodiments, the remote entry device 110, the central server 150, and/or the administrator device 180 includes at least a processor and a memory. Some embodiments described herein relate to a computer storage product with a non-transitory computer-readable medium (also referred to as a non-transitory processor-readable medium) having instructions or computer code thereon for performing various computer-implemented operations. The computer-readable medium (or processor-readable medium) is non-transitory in the sense that it does not include transitory propagating signals (e.g., a propagating electromagnetic wave carrying information on a transmission medium such as space or a cable). The media and computer code (also referred to herein as code) may be those designed and constructed for the specific purpose or purposes. Examples of non-transitory computer-readable media include, but are not limited to: magnetic storage media such as hard disks, optical storage media such as Compact Disc/Digital Video Discs (CD/DVDs), Compact Disc-Read Only Memories (CD-ROMs), magneto-optical storage media such as optical disks, carrier wave signal processing modules, and hardware devices that are specially configured to store and execute program code, such as Application-Specific Integrated Circuits (ASICs), Programmable Logic Devices (PLDs), Read- Only Memory (ROM) and Random-Access Memory (RAM) devices.

Although the present invention has been described with respect to specific embodiments thereof, various changes and modifications may be suggested to one skilled in the art and it is intended that the present invention encompass such changes and modifications as fall within the scope of the appended claims.

### EXAMPLES

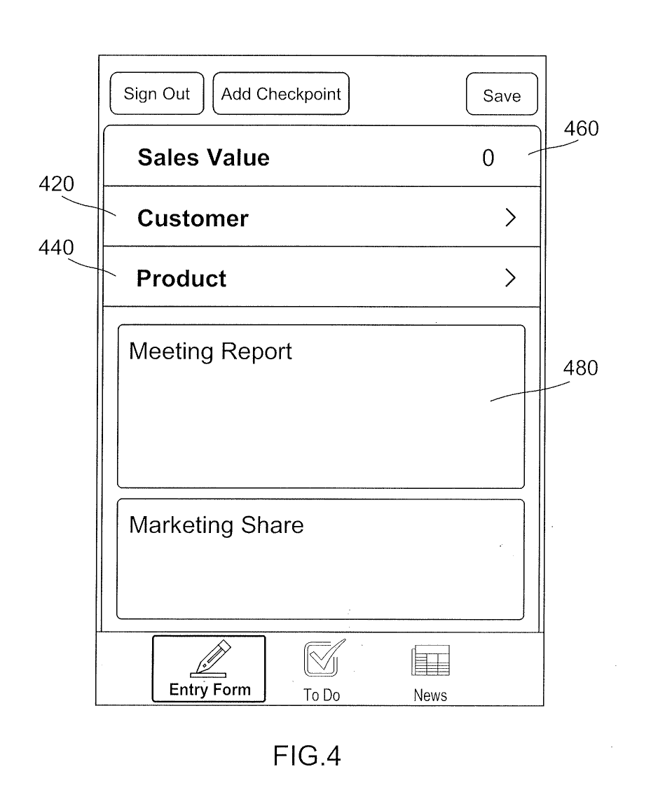

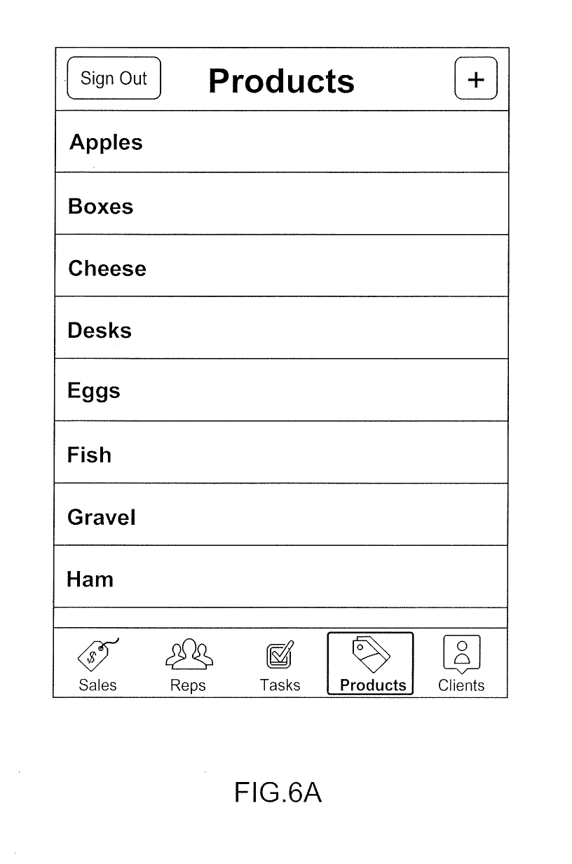

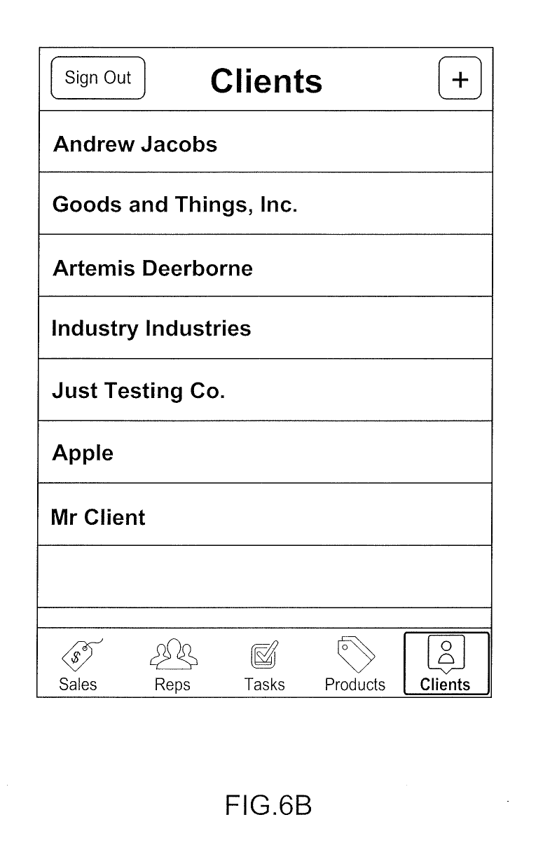

FIG. 4 shows an example of a customer visit report form (“entry form”) of the remote device 110 that allows the employee (e.g. a field agent) to enter information related to a particular customer. The information can include, for example, the customer name, the products sold or discussed, the value of any sales and any other information that the employee would like to include. This information can be entered via the remote entry device 110 by either selecting options from particular menus or by typing in information. For example, the customer can be selected from a list of customers (see FIG. 6B) by clicking on the customer option 420, the products can be selected from a list of products (see FIG. 6A) by clicking on the product option 440, or the employee can enter any other information in a section of the form that permits direct typing, for example the sales value via the entry field 460, or meeting report section 480 shown on FIG. 4. The employee can also manually enter date, time and geographic information by using the “add checkpoint” button in FIG. 4.

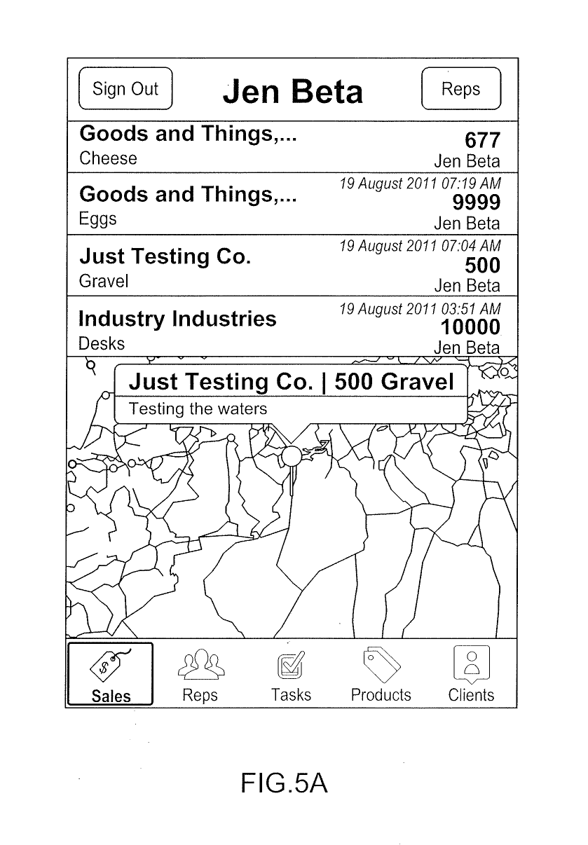

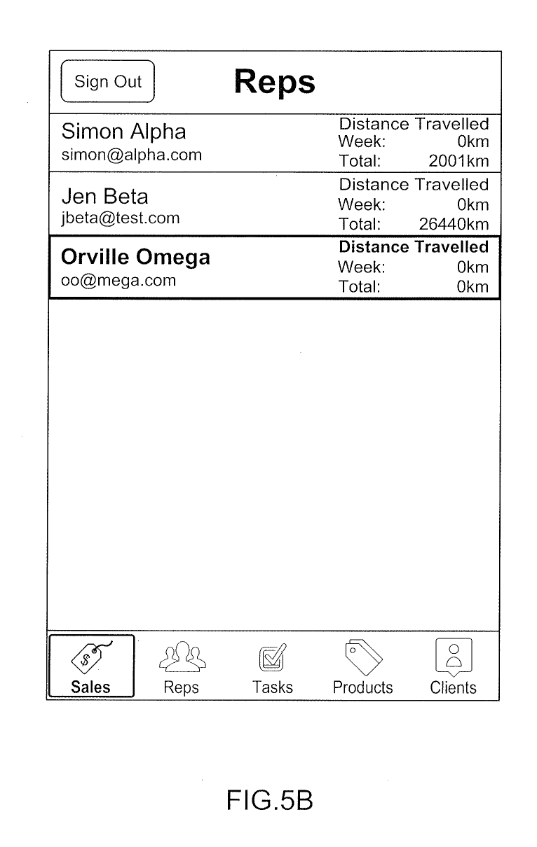

When the employee saves the customer information, the date, time and geographical information is collected via the remote entry device 110 as described above and saved with the customer information related to the employee as the customer visit report. All of this information can then be viewed via the administrator device 180. FIG. 5A is an example of the customer visit report as viewed by the administrator device 180. The administrator device 180 can view the reports for a particular employee, including the customer, or customers visited, the product sold, the date and time of the meeting (the date and time the meeting report was saved) and can also view the location of the customer on a map (FIG. 5B). In addition or alternatively, the administrator device 180 can view the information on the database or spreadsheet as shown below in Table 1.

TABLE 1
Example of information populating spreadsheet.

| Employee | Client | Product | Value | Time | Latitude | Longitude | Report |
|---|---|---|---|---|---|---|---|
| Jen Beta | Artemis | Apples | 4448 | 1313712309 | 39.18 | −103.7 | Everything went well |
| | Deerborne | | | | | | |
| Jen Beta | Industry | Desks | 10000 | 1313722309 | 37.18 | −99.7 | They might need |
| | Industries | | | | | | more desks later |
| Jen Beta | Goods and | Eggs | 9999 | 1313734741 | 32.904865 | −81.330869 | Eggs were slightly |
| | Things, Inc. | | | | | | rotten |

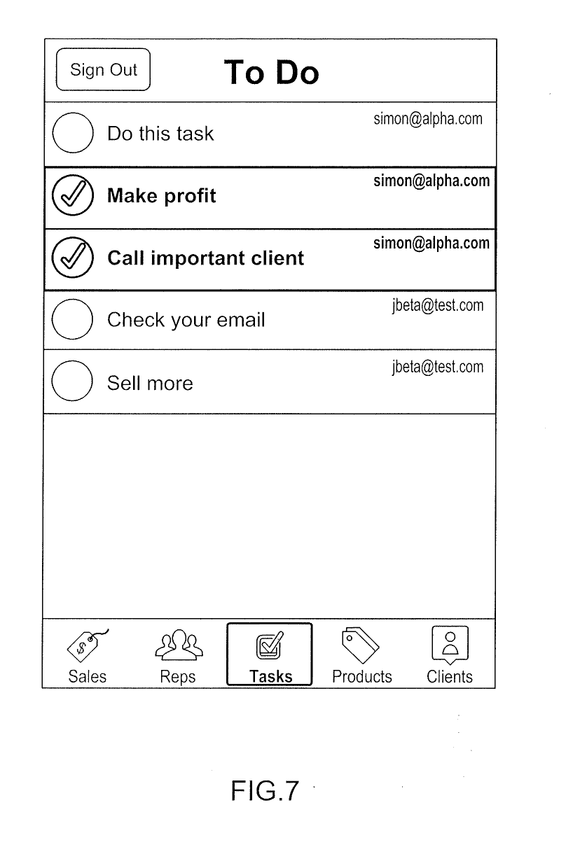

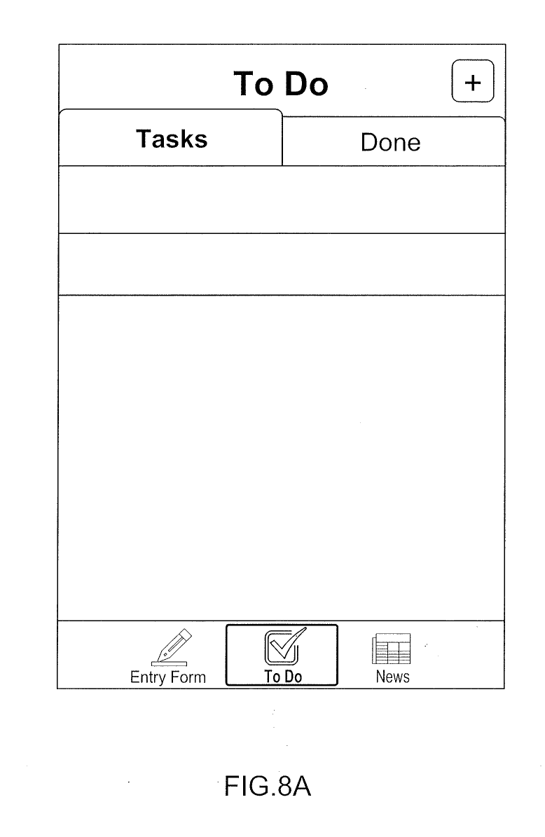

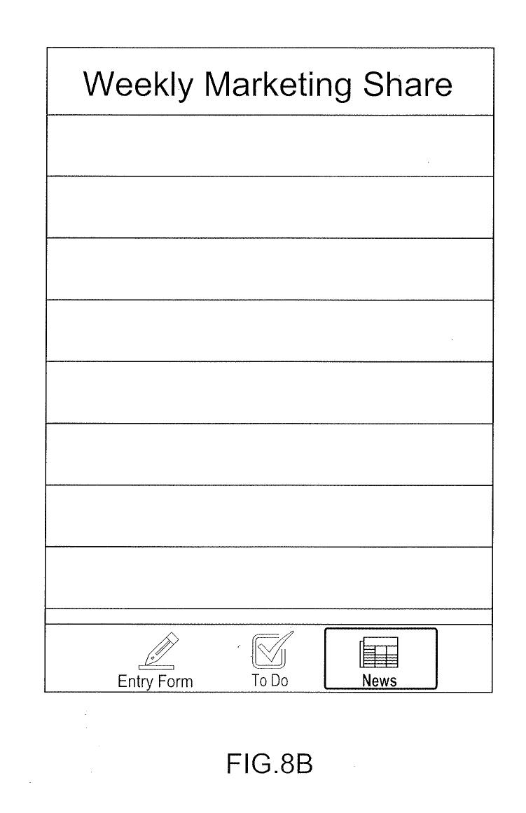

The administrator device 180 can also view the customer report for more than one employee at any given time, including the distance travelled by the employees (FIG. 5B). The administrator device 180 can also be used to assign tasks or duties to individual employees. For example, different instructions can be sent to different employees via the administrator device 180 as shown in FIG. 7. The individual employees will then be able to view tasks that they have been assigned via the remote entry device 110 (FIG. 8A).

The reports received from all the employees can be collated and used to determine other information, such as market share, that can then be provided via the administrator device 180 to the remote entry device (FIG. 8B).

The distance travelled by a particular employee can also be calculated by using the geographic information and services such as Google maps. For example, using the geographic information contained in Table 1 above, the distance travelled between Artemis Deerborne and Industry Industries is calculated as between 340 miles and 362 miles dependent upon the particular route taken.

What is claimed is:

1. A system comprising a remote device for generating customer reports, said remote device comprising:
a memory; and
a processor configured to execute instructions for:
receiving customer information;
determining geographic information associated with a geographic position of the remote device;
attaching the geographic information to the customer information to generate a customer report; and
transmitting the customer report.

2. The system of claim 1, further comprising a central server for receiving and storing the customer report.

3. The system of claim 2, further comprising an administrator device for viewing the customer report stored on the central server.

4. The computer system of claim 3, wherein the administrator device comprises an interface for viewing the geographic information of the customer report on a map.

5. The computer system of claim 3, wherein the administrator device is in communicaton with the remote device to send instructions to the remote device.

6. A method for generating customer reports, comprising:
receiving, by a remote device, customer information;
determining geographic information associated with a geographic position of the remote device;
attaching the geographic information to the customer information to generate a first customer visit report; and
transmitting the first customer visit report.

7. The method of claim 6, further comprising saving the first customer visit report to a central server.

8. The method of claim 7, further comprising accessing the first customer visit report by an administrator device.

9. The method of claim 8, further comprising viewing the the geographic information of the first customer visit report on a map via the administrator device.

10. The method of claim 8, further comprising receiving instructions at the remote device from the administrator device.

11. The method of claim 8, further comprising:
generating, by the remote device, a second customer visit report having geographic information attached thereto; and
saving the second customer visit report at the central server.

12. The method of claim 11, further comprising comparing the geographic information attached to the first customer visit report with the geographic information attached to the second customer visit report.

13. A method for managing a geographically distributed sales force, comprising:
receiving, by a plurality of remote devices, a plurality of customer information;
generating a customer visit report for each customer information, said generating including attaching geographic information associated with a geographic position of the remote device receiving the each customer information; and
transmitting each customer visit report upon said generating.

14. The method of claim 13, further comprising saving the plurality of customer visit reports to one or more central servers.

15. The method of claim 14, further comprising accessing the plurality of customer visit reports by an administrator device.

16. The method of claim 15, further comprising viewing the geographic information of each customer visit report on a map via the administrator device.

17. The method of claim 16, further comprising comparing the plurality of customer visit reports.

18. The method of claim 15, further comprising receiving information at at least one of the remote devices from the administrator device.

19. The method of claim 18, wherein the information is one or more of the following: tasks, to-do lists, and product news.

20. The method of claim 13, wherein each customer visit report further comprises user information associated therewith.
